(19) United States
(12) Patent Application Publication
(10) Pub. No.: US 2026/0067365 A1
(43) Pub. Date: Mar. 5, 2026

(54) Method and Gateway for Data Communication Between Automation Devices

(71) Applicant: Siemens Aktiengesellschaft, Muenchen (DE)

(72) Inventors: Rainer FALK, Erding (DE); Wolfgang BÖLDERL-ERMEL, Wendelstein (DE); Maik BOCHE, Oberasbach (DE)

(21) Appl. No.: 19/167,275

(22) PCT Filed: Feb. 29, 2024
(86) PCT No.: PCT/EP2024/055206

§ 371 Date: Sep. 19, 2025

(30) Foreign Application Priority Data
Mar. 23, 2023 (EP) 23163784.4

(51) Int. Cl. H04L 67/12; H04L 9/40; H04L 65/10

(52) U.S. Cl. CPC H04L 67/12; H04L 63/0245; H04L 65/1013

(57) ABSTRACT

Method and gateway for data communication between automation devices of an industrial automation system and a computer system via a wide-area network, wherein automation devices provide measurement or state variables at respective data points via a first interface of the gateway that includes a second interface for forwarding data streams respectively assigned to the data points to the computer system and that creates a first classification each data point in accordance with information security criticality of the data streams proceeding from there, where based on the associated first classification and an associated predefinable filtering or aggregation, the gateway in each case creates a second classification in accordance with the information security criticality, and in the event of at least a prior attempt to forward the data streams to the computer system, the gateway, in line with the associated second classifications, creates warnings formed from the associated second

### CROSS-REFERENCE TO RELATED APPLICATIONS

This is a U.S. national stage of application No. PCT/EP2024/055206 filed 29 Feb. 2024. Priority is claimed on European Application No. 23163784.4 filed 23 Mar. 2023, the content of which is incorporated herein by reference in its entirety.

### BACKGROUND OF THE INVENTION

### 1. Field of the Invention

The invention relates to a method and gateway for data communication between automation devices of an industrial automation system and at least one computer system via a wide-area network.

### 2. Description of the Related Art

Industrial automation systems are used for monitoring and open-and closed-loop control of industrial processes, in particular in the manufacturing, processing and building automation fields, and enable substantially autonomous operation of control systems, sensors, machinery, and industrial plants. An essential basis for the reliably providing monitoring and open-and closed-loop control functions via a process automation system is a complete and accurate record and map of the components of the industrial process automation system in an engineering or configuration system.

Interruptions to communication links between computer units of an industrial automation system or automation devices can lead to unwanted or unnecessary repetition of transmissions of a service request. In addition, messages that are not transmitted or are incompletely transmitted can, for example, prevent an industrial automation system from transitioning into or remaining in a safe operating state. This can ultimately lead to failure of an entire production plant and costly production downtime. In industrial automation systems, one particular problem regularly results from message traffic with relatively numerous but relatively short messages, whereby the above problems are exacerbated.

EP 2 660 667 A2 describes a cloud gateway for coupling an industrial control system to a cloud platform. The cloud gateway collects data from one or more industrial controllers, meters, sensors, or other automation devices. The cloud gateway optionally performs additional transformations on the data to add context, or to summarize, filter, reformat, or encrypt the data. The cloud gateway sends corresponding data, which is used by one or more cloud-based applications or services, to a cloud platform. The cloud gateway can facilitate cloud-based data collection from both fixed-location and mobile industrial systems. The cloud gateway can also support store-and-forward logic, allowing industrial data to be temporarily stored in local storage in the event that communication between the cloud gateway and the cloud platform is disrupted.

EP 2 710 782 B1 relates to a method for monitoring a VPN tunnel that has been set up and cryptographically protected for monitoring data communication between a controller and a control unit for functional scope. A VPN box positioned on the VPN tunnel delivers an operating safety/safe-for-use signal to the control unit if monitoring has revealed that the VPN tunnel fulfills specified features, such that a regular operating state can be adopted or maintained at the control unit.

EP 3 267 661 B1 discloses a network system that comprises a first network node with a plurality of network devices. The network devices have identification parameters for identification purposes. A second network node with cloud computing infrastructure and a cloud connector with a first interface and a second interface are also provided. The cloud connector is connected via the first interface to the first network node and via the second interface to the second network node. The cloud connector is furthermore configured to perform a passive scan and an active scan of the first network node, such that at least one of the network devices can be identified by the cloud connector, where at least one network device profile from the second network node is loadable into the cloud connector. The active scan is performed based on the at least one loaded network device profile.

EP 3 534 592 A1 describes a method for data communication between an industrial automation system and a server system via a wide-area network, in which automation devices transmit measured values or state information and classifications associated therewith to a data distribution unit of the automation system via communication links within the automation system. With the assistance of the classifications, the data distribution unit organizes the measured values or state information hierarchically into selectable categories for data communication and transmits measured values or state information belonging to the categories selected for data communication to the server system and bundled within a specifiable number of communication links via the wide-area network to the server system. The data distribution unit limits the bandwidth of or terminates communication links with the server system on an event-controlled basis or as a function of an operating state of the industrial automation system.

EP 3 001 884 B1 discloses a method for monitoring a security gateway, such as a firewall, which receives a stream of data packets via a first interface, checks this data stream against filtering rules, and outputs it to a second interface. The method comprises method steps of duplicating and outputting the data stream to the second interface, checking the output data stream for inadmissible data traffic, and sending a warning message to the security gateway if inadmissible data traffic is identified in the data stream. The method further comprises the method step of restricting the data stream through the security gateway when the warning message is received in the security gateway.

EP 2 656 581 B1 relates to a network coupling device for a packet-based field data network having at least two communication interfaces, an integrated transmission means, and a monitoring device that is coupled to the communication interfaces of the network coupling device. The two communication interfaces are each couplable with a data network. The integrated transmission means is coupled with the communication interface of the network coupling device and configured so as to transmit data packets between the communication interfaces. The monitoring device is configured to monitor whether a data packet corresponding to a data packet sent via a communication interface of the network coupling device has been received via another communication interface of the network coupling device.

Data-driven services for operational technology (OT) applications, in particular for usage-dependent insurance or predictive maintenance, require that data acquired from an OT environment during operation be transmitted to third parties. Any leaks of further, sensitive data other than the data required for the services must be prevented.

### SUMMARY OF THE INVENTION

In view of the foregoing, it is therefore an object of the present invention provide an apparatus and method for data communication between automation devices of an industrial automation system and at least one computer system via a wide-area network that enables reliable, traceable, and controllable data communication while excluding sensitive operating data.

This and other objects and advantages are achieved in accordance with the invention by a gateway and by a method in which automation devices of an industrial automation system provide measurement or state variables in each case at a data point via a first interface of a gateway of the automation system. The gateway comprises a second interface for forwarding data streams in each case associated with the data points to a computer system via a wide-area network. Data points particularly represent variables within a processing or manufacturing automation system that are displayed, for example, in a control center or a process visualization system. In principle, data points can also represent complex logical devices with a plurality of sensor or actuator components.

In accordance with the invention, the gateway in each case creates a first classification of the data points in accordance with the information security criticality of the data streams arising therefrom. The gateway moreover performs respectively specifiable filtering or aggregation of the data streams arising from the data points before the data streams are forwarded via the second interface. The specified filtering or aggregation can particularly involve direct forwarding or data processing. The data streams preferably comprise end-to-end encrypted data. Here, the respective automation device and computer system are advantageously end points of the data streams.

The measurement or state variables may, for example, comprise semantic attributes in accordance with the Open Platform Communications (OPC) Unified Architecture as the associated first classifications. Alternatively, the measurement or state variables may be transmitted to the gateway by the automation devices in accordance with the message queuing telemetry transport protocol (MQTT). Here, MQTT topics are associated with the measurement or state variables as the first classifications, and messages comprising the measurement or state variables are advantageously transmitted with a specifiable quality of service (Qos).

In accordance with the invention, the gateway in each case creates a second classification in accordance with information security criticality based on the respective first classification and the respective specifiable filtering or aggregation. In the event of direct forwarding, the second classifications are, for example, identical to the respective first classification. In accordance with the invention, in the event of at least attempted forwarding of the data streams to the computer system, the gateway furthermore creates, in accordance with the respective second classifications, warnings comprising the respective second classifications and signals these warnings on a user interface. In this way, OT users can check that only data streams associated with agreed data points are actually transmitted. In particular, OT users can identify if data other than that agreed or permitted is transmitted.

In accordance with a preferred embodiment of the present invention, upon receipt of the data streams at the first interface in accordance with the respective first classifications, the gateway signals warnings comprising the respective first classifications and signals these warnings on the user interface. In this way, inadmissible data outflows from the industrial automation system can be identified at an early stage and measures to prevent them rapidly initiated.

In accordance with the invention, data processing steps applied to the respective data stream between the first and second interfaces are ascertained with the assistance of the first and second classifications. Based on the ascertained data processing steps, in each case a security attestation digitally signed by the gateway is created and transmitted to an operator of the industrial automation system for evaluation. The security attestations can furthermore each also be transmitted to a recipient associated with the computer system for evaluation. The recipient can thus verify with the assistance of the security attestations whether the respective data streams comprise trustworthy data.

In accordance with a further advantageous embodiment of the present invention, the warnings are each provided with a digital signature associated with the gateway. In addition, in the event of a warning, forwarding of the respective data stream via the second interface is blocked or forwarding is continued with an alarm. Forwarding is preferably blocked for second classifications that are defined as inadmissible for the forwarding of data streams via the second interface. In this way, critical data outflows from the industrial automation system can be reliably prevented.

The gateway in accordance with the invention is provided for implementing the method in accordance with the disclosed embodiments and is configured such that automation devices each provide measurement or state variables at a data point via a first interface of the gateway. The gateway comprises a second interface for forwarding data streams in each case associated with the data points to a computer system via a wide-area network. The gateway is moreover configured in each case to create a first classification of the data points according to the information security criticality of the data streams arising therefrom and to perform respectively specifiable filtering or aggregation of the data streams arising from the data points before the data streams are forwarded via the second interface.

The gateway in accordance with the invention is furthermore configured to create a second classification in accordance with information security criticality based on the respective first classification and the respective specifiable filtering or aggregation. In the event of at least attempted forwarding of the data streams to the computer system, the gateway is furthermore configured to create, in accordance with the respective second classifications, warnings comprising the respective second classifications and to signal them on a user interface.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The present invention is explained in more detail below with the assistance of an exemplary embodiment based on the drawings, in which:

FIG. 1 shows an industrial automation system comprising a plurality of automation devices that is connected to a cloud computing system via a gateway in accordance with the invention;

FIG. 2 is a detail representation of a monitoring functional unit of the gateway shown in FIG. 1; and

FIG. 2 is a flowchart of the method in accordance with the invention.

### DETAILED DESCRIPTION OF THE EXEMPLARY EMBODIMENTS

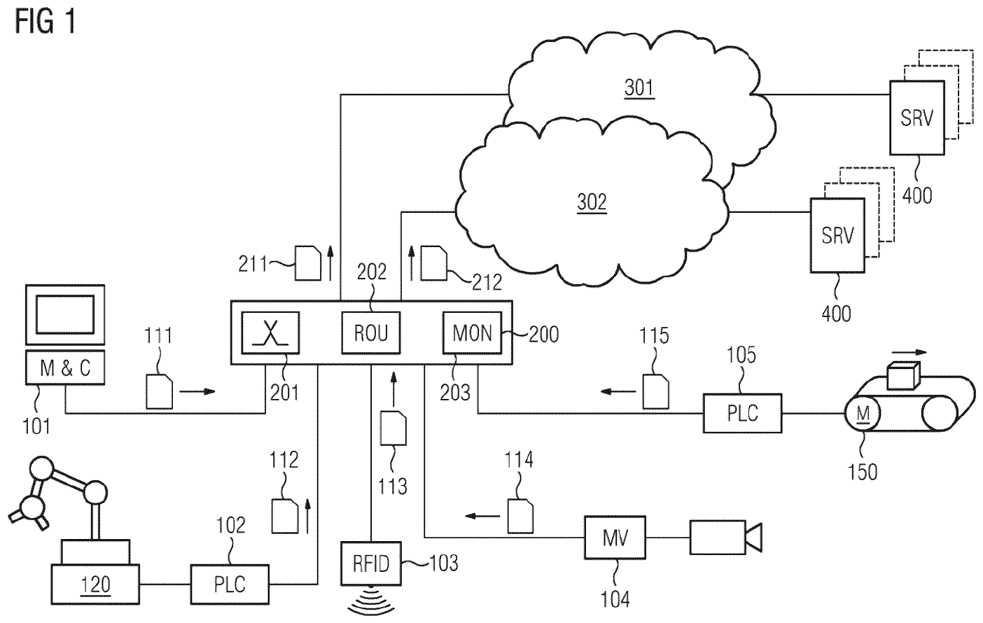

The industrial automation system shown in FIG. 1 comprises a plurality of automation devices 101, 102, 103, 104, 105, which in the present exemplary embodiment are at least logically connected to a gateway 200. The gateway 200 is connected via internet communication links 301, 302 to one or more cloud computing systems 400. The cloud computing systems 400 each comprise a plurality of servers that provide IT infrastructure, such as storage space, computing power or application software, as a service.

The automation devices may, for example, be operator control and monitoring stations 101, programmable controllers 102, 105, RFID readers 103 or systems 104 for machine image processing. In addition to the automation devices 101, 102, 103, 104, 105, network infrastructure devices, such as switches, routers or firewalls, can also be directly or indirectly connected to the gateway 200. These network infrastructure devices particularly serve to connect programmable controllers, input/output units (I/O modules) or operator control and monitoring stations of the industrial automation system. In the present exemplary embodiment, the programmable controllers 102, 105 each comprise a communication module, a central unit, and at least one input/output unit. In principle, input/output units can also be configured as distributed peripheral modules that are located remotely from a programmable controller.

The programmable controllers 102, 105 can be connected, for example, to the gateway 200, a switch or router or additionally to a field bus via communication modules. Input/output units serve to exchange control and measurement variables between the programmable controllers 102, 105 and machinery or apparatuses 120, 150 controlled by the programmable controllers 102, 105. The central units are particularly provided to ascertain suitable control variables from acquired measured variables. In the present exemplary embodiment, the above components of the programmable controllers 102, 105 are interconnected via a backplane bus system.

An operator control and monitoring station 101 serves to visualize process data or measurement and control variables that are processed or acquired by programmable controllers, input/output units, or sensors. In particular, an operator control and monitoring station 101 is used to display values of a control loop and to modify control parameters. Operator control and monitoring stations 101 comprise at least one graphical user interface, an input device, a processor unit, and a communication module.

In the present exemplary embodiment, the gateway 200 comprises a processor, memory, an integrated switch 201, which is provided in particular for connecting the automation devices 101, 102, 103, 104, 105, a router module 202 for the internet communication link 301, 302 and a monitoring functional unit 203. The monitoring functional unit 203 is configured to receive messages 111, 112, 113, 114, 115 transmitted by the automation devices 101, 102, 103, 104, 105 with measurement or state variables via communication links or data links within the automation system.

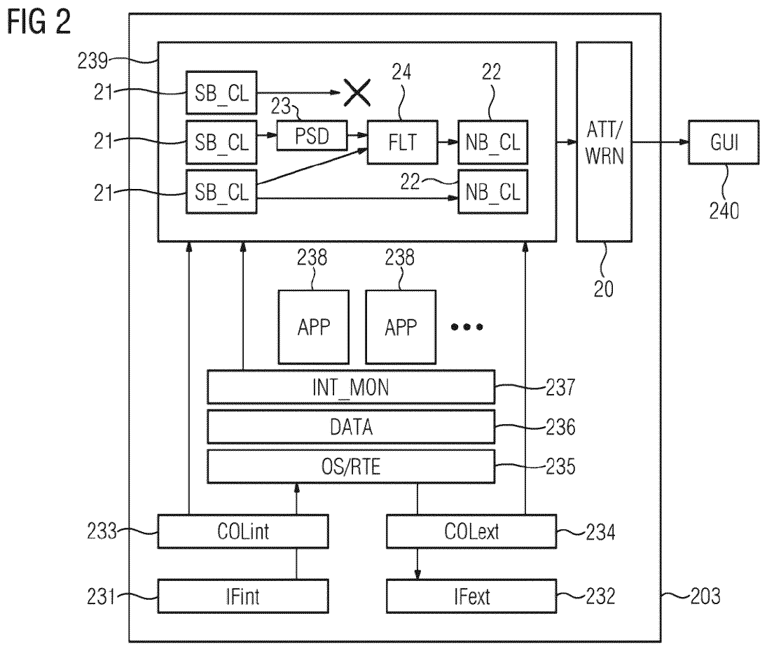

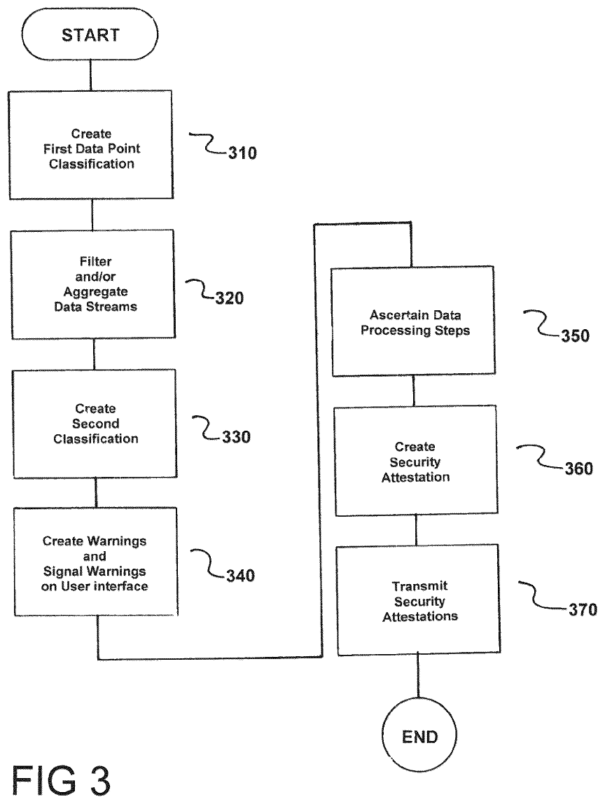

The automation devices 101, 102, 103, 104, 105 provide the measurement or state variables in each case at a data point via a first interface 231 shown in FIG. 2 of the monitoring functional unit 203. The monitoring functional unit 203 comprises a second interface 232 for forwarding data streams in each case associated with the respective data points to the cloud computing systems 400. The data streams preferably comprise end-to-end encrypted data. The respective automation device 101, 102, 103, 104, 105 and the respective cloud computing system 400 are end points of the data streams.

In addition to the first interface 231 and the second interface 232 and acquisition units 233, 234 for incoming or outgoing data streams associated with these interfaces, the monitoring functional unit 203 comprises an operating system or an app execution environment 235 and a data bus 236, via which apps 238 provided by the monitoring functional unit 203 can exchange data. The apps 238 perform, for example, filtering, aggregation or other preprocessing of the data streams. As an alternative to preprocessing the data streams, the latter can be forwarded directly or without further data processing via the second interface 232 toward the cloud computing systems 400.

In the present exemplary embodiment, the monitoring functional unit 203 moreover comprises a data stream integrity monitor 237 that compares observed, dynamically ascertained data flows with a reference policy of admissible data flows. This makes it possible to monitor that only data ascertained in an approved, admissible manner is actually forwarded in particular to the cloud computing systems 400. In the event of any deviation from the reference policy, a predetermined action can be initiated or at least a warning signaled. Data path approval information or data path authorization information can furthermore be managed. This information indicates when and by whom a specific data flow was defined as admissible.

In the present exemplary embodiment, the monitoring functional unit 203 acquires raw data from the automation devices 101, 102, 103, 104, 105 via the first interface 231 and the acquisition unit 233 associated with this interface for incoming data streams from the automation devices 101, 102, 103, 104, 105. This raw data may, for example, be critical production data that reveals secrets about a production process. The monitoring functional unit 203 furthermore acquires data streams exiting toward the cloud computing systems 400 via the second interface 232 and the acquisition unit 234 associated with this interface. Data admissibly transmitted via the second interface 232 is less critical if, for example, it is aggregated data, such as compressed usage values or KPI parameters.

For example, an app 238 can ascertain as a usage value that a bottling plant has been running for 23 hours. This value can be admissibly transmitted to external systems, such as the cloud computing systems 400. In the present exemplary embodiment, the raw information underlying the usage value of a run time of 23 hours that 14367 bottles have been filled should not be provided to an external system outside the bottling plant, as this is business-critical production data. Should an outgoing data flow from a data point for filled bottles occur without preprocessing toward an external system via the second interface 232, this should be identified as an inadmissible data flow.

For this purpose, the monitoring functional unit 203 of the gateway 200 uses a classification component 239 to create a first classification 21 of the data points in accordance with the information security criticality of the data streams arising therefrom. In the present exemplary embodiment, the monitoring functional unit 203 uses apps 238 to perform in each case specifiable pseudonymization 23 and filtering or aggregation 24 of the data streams arising from the data points before they are forwarded via the second interface 232. In this way, the monitoring functional unit 203 can create aggregated measurement or state variables from measurement or state variables or raw data transmitted by the automation devices 101, 102, 103, 104, 105.

Based on the respective first classification 21 and the respective specifiable pseudonymization 23 and filtering or aggregation 24, the classification component 239 in each case creates a second classification 22 in accordance with information security criticality. In the case of direct forwarding, i.e., without preprocessing within the gateway 200, the second classifications 22 are identical to the respective first classification 21.

In the event of at least attempted forwarding of the data streams to one of the cloud computing systems 400, the monitoring functional unit 203 creates, in accordance with the respective second classifications 22 (depending on security criticality), warnings 20 comprising the respective second classifications and signals these warnings on a user interface 240. If the second classifications 22 are non-critical, then messages 211, 212 including the measurement or state variables, preferably in aggregated form, can be forwarded to the respective cloud computing system 400 via the second interface 232. In the present exemplary embodiment, upon receipt of the data streams at the first interface 232, the monitoring functional unit 203 can also create, in accordance with the respective first classifications 21 (depending on security criticality), warnings comprising the respective first classifications and signal them on the user interface 240.

In the event of a data flow identified as inadmissible, the gateway 200 can, for example, be restarted (rebooted) or reconfigured. Alternatively or additionally, all communication links to external systems can be interrupted. Instead of stopping a data transfer, it is in principle possible to document an inadmissible data transmission (preferably tamper-protected), for example, in a log entry or by a warning message: “ERROR: Access to Data Point not Permitted by Dataflow Contract”.

The measurement or state variables may, for example, comprise semantic attributes in accordance with the OPC Unified Architecture as the associated first classifications. Alternatively, the measurement or state variables can be transmitted to the gateway 200 by the automation devices 101, 102, 103, 104, 105 in accordance with the message queuing telemetry transport protocol (MQTT). Here, MQTT topics are associated with the measurement or state variables as the first classifications, and messages 111, 112, 113, 114, 115 comprising the measurement or state variables are transmitted to the gateway 200 with a specifiable quality of service (QoS). In accordance with a further alternative, the measurement or state variables can, for example, also be transmitted in accordance with the advanced message queuing protocol (AMQP).

The warnings 20 are each preferably provided with a digital signature associated with the gateway 200, where, forwarding of the respective data stream via the second interface is blocked or forwarding is continued with an alarm in the event of a warning 20. Forwarding is advantageously blocked for second classifications 22 that are defined as inadmissible for the forwarding of data streams via the second interface 232.

Data processing steps applied to the respective data stream between the first interface 231 and the second interface 232 can in particular be ascertained with the assistance of the first classifications 21 and the second classifications 22. Base on the ascertained data processing steps, in each case a security attestation 20 digitally signed by the gateway 200 can be created. The security attestations 20 can be transmitted to an operator of the industrial automation system for evaluation. In addition, the security attestations 20 can each be transmitted to a recipient associated with one of the cloud computing systems 400 for evaluation. The recipient can verify with the assistance of the security attestations 20 whether the respective data stream comprises trustworthy data. Security attestations 20 can, for example, state which data flow categories are currently occurring or have occurred in a current period, such as the last minute, 10 minutes, 1 hour or 24 hours.

In addition to the first classifications 21 and the second classifications 22, the monitoring functional unit 203 can also ascertain a configuration of the respective automation device 101, 102, 103, 104, 105 and evaluate it in combination with the classifications. For example, a digital twin of the monitoring functional unit 203 or of the gateway 200 can be formed at runtime on this basis and based on a data processing model abstracted with regard to incoming and outgoing data streams. Data processing streams can thus be described in terms of their type.

In accordance with another advantageous embodiment, a user can be shown which real data is concealed by the respective data flow classifications. Data streams can be acquired via the acquisition units 233, 234 without feedback, in particular by using a data diode. In addition to being integrated into the gateway 200, monitoring functional unit 203 can also be implemented as an add-on component for existing gateways.

FIG. 3 is a flowchart of the method for data communication between automation devices of an industrial automation system and at least one computer system via a wide-area network, where the automation devices 101, 102, 103, 104, 105 provide measurement and/or state variables in each case at a data point via a first interface 231 of a gateway 200 of the automation system, and where the gateway 200 comprises a second interface 232 for forwarding data streams 111-114, 211-212 in each case associated with the data points to the computer system 400.

The method comprises creating, by the gateway 200, in each case a first classification 21 of the data points in accordance with information security criticality of the data streams 111-114, 211-212 arising therefrom, as indicated in step 310.

Next, the gateway performs respectively specifiable filtering and/or aggregation 24 of the data streams 111-114, 211-212 arising from the data points before the data streams are forwarded via the second interface, as indicated in step 320.

Next, the gateway 20 creates, in each case, a second classification 22 in accordance with the information security criticality based on the respective first classification and the respective specifiable filtering and/or aggregation, as indicated in step 330.

Next, in accordance with the respective second classifications, the gateway 200 creates warnings 20 comprising the respective second classifications and signals the created warnings on a user interface 240, in an event of at least attempted forwarding of the data streams 111-114, 211-212 to the computer system 400, as indicated in step 340.

Next, data processing steps applied to the respective data stream 111-114, 211-212 between the first and second interfaces 231, 232 are ascertained assisted by the first and second classifications 21, 22, as indicated in step 350.

Next, a security attestation 20 digitally signed by the gateway 200 in each case is created based on the ascertained data processing steps, as indicate in step 360.

Next, security attestations 20 are transmitted to an operator of the industrial automation system for evaluation, as indicated in step 370.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-12. (canceled)

13. A method for data communication between automation devices of an industrial automation system and at least one computer system via a wide-area network, the automation devices providing at least one of measurement and state variables in each case at a data point via a first interface of a gateway of the automation system, and the gateway comprising a second interface for forwarding data streams in each case associated with the data points to the computer system, the method comprising:
creating, by the gateway, in each case a first classification of the data points in accordance with information security criticality of the data streams arising therefrom;
performing, by the gateway, respectively specifiable filtering and/or aggregation of the data streams arising from the data points before the data streams are forwarded via the second interface;
creating, by the gateway, in each case a second classification in accordance with the information security criticality based on the respective first classification and the respective specifiable filtering and/or aggregation;
creating, by the gateway, in accordance with the respective second classifications, warnings comprising the respective second classifications and signals said created warnings on a user interface, in an event of at least attempted forwarding of the data streams to the computer system;
ascertaining data processing steps applied to the respective data stream between the first and second interfaces assisted by the first and second classifications;
creating a security attestation digitally signed by the gateway in each case based on the ascertained data processing steps; and
transmitting security attestations to an operator of the industrial automation system for evaluation.

14. The method as claimed in claim 13, further comprising:
generating, by the gateway, warnings comprising the respective first classifications and signaling said warning on the user interface upon receipt of the data streams at the first interface in accordance with the respective first classifications.

15. The method as claimed in claim 13, wherein the security attestations are each transmitted to a recipient associated with the computer system for evaluation; and wherein the recipient verifies, assisted by the security attestations, whether the respective data streams comprise trustworthy data.

16. The method as claimed in claim 14, wherein the security attestations are each transmitted to a recipient associated with the computer system for evaluation; and wherein the recipient verifies, assisted by the security attestations, whether the respective data streams comprise trustworthy data.

17. The method as claimed in claim 13, wherein at least one of the specified filtering and aggregation involves direct forwarding or data processing.

18. The method as claimed in claim 14, wherein at least one of the specified filtering and aggregation involves direct forwarding or data processing.

19. The method as claimed in claim 15, wherein at least one of the specified filtering and aggregation involves direct forwarding or data processing.

20. The method as claimed in claim 17, wherein the second classifications are identical to the respective first classification in an event of direct forwarding.

21. The method as claimed in one of claim 13, wherein the warnings are each provided with a digital signature associated with the gateway; and wherein forwarding of the respective data stream via the second interface is blocked or forwarding is continued with an alarm in an event of a warning.

22. The method as claimed in claim 21, wherein forwarding is blocked for second classifications which are defined as inadmissible for the forwarding of data streams via the second interface.

23. The method as claimed in claim 13, wherein the data streams comprise end-to-end encrypted data.

24. The method as claimed in claim 23, wherein the respective automation device and the computer system comprise end points of the data streams.

25. The method as claimed in claim 13, wherein at least one of the measurement and state variables comprise semantic attributes in accordance with Open Platform Communications (OPC) Unified Architecture as the associated first classifications.

26. The method as claimed in claim 13, wherein at least one of the measurement and state variables are transmitted to the gateway by the automation devices in accordance with message queuing telemetry transport protocol (MQTT);
wherein MQTT topics are associated with at least one of the measurement and state variables as the first classifications; and
wherein messages comprising at least one of the measurement and state variables are transmitted with a specifiable quality of service.

27. A gateway comprising:
a processor;
memory;
a first interface, the gateway being configured such that automation devices each provide at least one of measurement and state variables at a data point via the first interface of the gateway; and
a second interface for forwarding data streams associated with data points to a computer system via a wide-area network;
wherein the gateway is further configured to:
create a first classification of the data points in accordance with an information security criticality of the data streams arising therefrom;
perform respectively specifiable filtering and/or aggregation of the data streams arising from the data points before the data streams are forwarded via the second interface;
create in each case a second classification in accordance with the information security criticality based on the respective first classification and the respective specifiable filtering and/or aggregation;
create, in accordance with the respective second classifications, warnings comprising the respective second classifications and signal said warning on a user interface, in an event of at least attempted forwarding of the data streams to the computer system;
ascertain data processing steps applied to the respective data stream between the first and second interfaces assisted by the first and second classifications;
create a digitally signed security attestation, based on each ascertained data processing steps; and
transmit the security attestations to an operator of the industrial automation system for evaluation.
